(19) United States
(12) Patent Application Publication
(10) Pub. No.: US 2004/0223706 A1
(43) Pub. Date: Nov. 11, 2004

(54) Multiple optical fiber coupler manufacturing apparatus

(76) Inventors: Hong Seok Seo, Daejon-Shi (KR); Yong Gyu Choi, Daejon-Shi (KR); Kyong Hon Kim, Daejon-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/252,076

(22) Filed: Sep. 20, 2002

(30) Foreign Application Priority Data
May 31, 2002 (KR) 2002-30542

(51) Int. Cl. G02B 6/255

(52) U.S. Cl. 385/96

(57) ABSTRACT

A multiple optical fiber coupler manufacturing apparatus which can manufacture a plurality of the optical fiber couplers is disclosed. The multiple optical fiber coupler manufacturing apparatus comprises multiple micro torch for heating portions of a plurality of optical fibers so as to fuse the optical fibers two by two; multiple optical fiber holders symmetrically arranged on the basis of said multiple micro torch, for fixing the plurality of the optical fibers two by two at a same interval; and a carrying stage having said multiple micro torch and said multiple optical fiber holders mounted thereon such that said multiple optical fiber holder can be moved.

By this structure, the plurality of the optical fiber couplers having a same specification can be manufactured for a short time, and, after the manufacture thereof, the packaging process can be performed at once, thereby the cost and time therefor can be reduced.

### BACKGROUND OF THE INVENTION

1. Field of the Invention

The present invention relates to an optical fiber coupler manufacturing apparatus, more particularly, to a multiple optical fiber couplers manufacturing apparatus, which can manufacture a plurality of the optical fiber couplers.

2. Description of the Prior Art

Recently, various methods for increasing the communication speed have been proposed. These methods are divided into a time division multiplexing (TDM) method which increases the speed of an electronic circuit, an optical time division multiplexing (OTDM) method for forming an optical-short pulse, and a wavelength division multiplexing (WDM) method for combining optical signals having a plurality of wavelength which are different from each other and transmitting it through an optical fiber.

Among them, the concept of the WDM transmitting technique is first known only several tens years ago, and it has been researched all over the world, thereby the fast growth such as the development of a commercial equipment has been progressed up to now. This technique is the method for carrying several channels to respective different wavelengths and transmitting it through one optical fiber core, irrespective of the transmission speed, and, hereafter, will be used as the important technique in an optical communication field of the very high speed information communication network. More recently WDM techniques have been rapidly developed into dense wavelength division multiplexing (DWDM) in which the interval between the channels became up to 0.2 nm by the development of an arrayed waveguide grating or filter WDM techniques. In this DWDM system, the application of the optical fiber coupler has a technical limitation because it cannot divide and combine optical channels having channel interval less than 10 nm due to many problems, such as polarization dependent loss, insertion loss, and channel crosstalks in manufacturing the optical fiber coupler.

For example, if the optical fiber coupler of which the interval between the channels is 5 nm is manufactured, the insertion loss thereof becomes equal to and more than 1 dB and the polarization dependent loss becomes equal to and more than 1 dB, thereby it is not suitable as an optical device. Furthermore, in optical communication, the channel isolation must be equal to and more than 20 dB, but is as low as 10 to 15 dB at the present time.

However, as an application field of the optical fiber coupler, optical combiner, between pump laser diode and a signal channel for an erbium doped optical fiber amplifier having relatively large channel interval, has been still remained as a good potential. Recently optical fiber couplers in thulium doped fiber amplifier for C-band, or Raman amplifiers have been frequently used for combining multiple pump laser diodes with different wavelengths. In the metro network, it has been used directly as channel combiners for a CWDM (coarse WDM) (for example, the channel interval is about 20 nm). Therefore, the cheap optical fiber coupler has still a competitive position in a market as a low cost optical device.

However, the optical fiber coupler manufacturing apparatus according to the above-mentioned prior art is designed to fabricate the optical fiber coupler one by one, and, accordingly, the process time is relatively long and cumbersome processes are repeated in manufacturing optical fiber couplers having the same characteristics. Also, in order to manufacture a plurality of the optical fiber couplers having same characteristics, it is troublesome in that the optical characteristic should be measured respectively every time.

### SUMMARY OF THE INVENTION

Thus, the object of the present invention is to solve the above-mentioned problems, and therefore is to provide an optical fiber coupler manufacturing apparatus which can reduce the cost for manufacturing the optical fiber coupler and can simultaneously manufacture a plurality of the optical fiber coupler by using one optical fiber coupler manufacturing apparatus.

The another object of the present invention is to manufacture an optical fiber coupler manufacturing apparatus which can reduce the manufacturing time of the optical fiber coupler and can produce a large quantity of the products having a same specification at once.

The further object of the present invention is to obtain the optical fiber coupler securing a same specification only by measuring the characteristic of one optical fiber coupler without measuring the other optical fiber couplers, while the optical fiber couplers having same specification such as same structure and same optical characteristic are severally manufactured in one manufacturing process, and accomplished by the packaging process at once.

The object of the present invention is to develop the method for producing one coupler by driving an existing manufacturing apparatus into the method for producing the large quantity of the couplers at once, among the methods for fusing and adhering the optical fibers to manufacture the optical fiber coupler.

For accomplishing the above-mentioned objects, the present invention provides a multiple optical fiber coupler manufacturing apparatus comprising a multiple micro torch for heating portions of a plurality of optical fibers so as to fuse the optical fibers two by two; multiple optical fiber holders symmetrically arranged on the basis of said multiple micro torch, for fixing the plurality of the optical fibers two by two at a same interval; and a carrying stage having said multiple micro torch and said multiple optical fiber holders mounted thereon such that said multiple optical fiber holder can be moved.

In addition, the multiple optical fiber coupler manufacturing apparatus may further comprise a driving motor for fixing and moving the optical fiber, in order to move said optical fiber holder and a packaging portion for packaging each optical fiber coupler.

Preferably, pairs of said plurality of the optical fibers have the same twisted number, and the portion of the optical fiber to be heated is stripped by the same length in order to fuse the optical fiber

On the other hand, in order to apply flame to each of the connected portions of the optical fiber couplers, the micro torch may be manufactured such that a pair of torch tips symmetrically arranged are arranged at a certain interval and the pair of torch tips corresponds to one of the optical fiber couplers and torch tips are arranged at a certain interval, or said multiple micro torch may be manufactured so as to fuse all the optical fiber couplers which are simultaneously manufactured, by using a pair of torch tips.

### BRIEF DESCRIPTION OF THE ATTACHED DRAWINGS

FIG. 1 shows an optical fiber coupler manufacturing apparatus according to the preferred embodiment of the present invention.

FIG. 2 is an enlarged view of multiple optical fiber holders shown in FIG. 1.

FIGS. 3A and 3B show an example of manufacturing a multiple micro torch shown in FIG. 1.

FIG. 4 is an enlarged section view of a packaging portion shown in FIG. 1.

FIG. 5 is a conceptional diagram illustrating the packaging process using the optical fiber coupler manufacturing apparatus according to the preferred embodiment of the present invention.

### DESCRIPTION OF THE PREPERRED EMBODIMENT

Hereinafter, the embodiments of the present invention will be explained with reference to the accompanying drawings. However, the embodiment of the present invention can be changed into a various type, and it should be not understood that the scope of the present invention is limit to the following embodiments. The embodiments of the present invention are provided in order to explain the present invention to those skilled in the art.

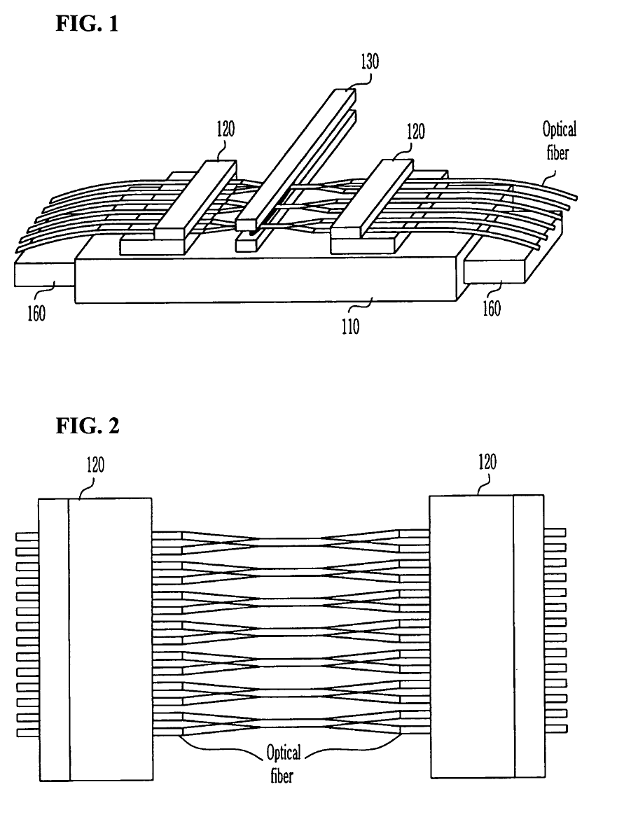

FIG. 1 shows an optical fiber coupler manufacturing apparatus according to the preferred embodiment of the present invention.

Referring to FIG. 1, the optical fiber coupler manufacturing apparatus comprises multiple optical fiber holders 120, a multiple micro torch 130, and a carrying stage 110 on which they can be mounted. Preferably, driving motors 160 which can move the multiple optical fiber holder 120 on the carrying stage 110 are mounted. Also, the optical fiber coupler manufacturing apparatus may further include a built-in packaging portion 140 for packaging the manufactured optical fiber coupler.

The carrying stage 110 has the structure for mounting the multiple optical fiber holders 120, the multiple micro torch 130, and the packaging portion thereon, and the driving motors 160 is mounted in the carrying stage 110 and provides a function of extending the both ends of a plurality of the optical fibers in an uniform speed and with an uniform force so that the main part of the optical fiber coupler has a taper shape.

The optical fiber holder 120 is a part for determining the taper shape of the optical fiber, has recesses such that the optical fiber is uniformly fixed by suitable force, wherein the recesses are uniformly arranged two by two. FIG. 2 is an enlarged view of the multiple optical fiber holders 120 shown in FIG. 1.

Referring to FIG. 2, the multiple optical fiber holder 120 has a structure in which the recesses for fixing the optical fibers are formed so as to arrange the optical fibers in a certain interval. The insertion loss of the manufactured optical fiber coupler depends on the interval and the arrangement of these recesses. An extremely wide interval or an extremely narrow interval becomes a primary factor in the increment of the insertion loss. At this time, the pairs of the optical fibers have the same twisted number, respectively, and the polymer jacket portion of the optical fiber to be heated by the micro torch is stripped in same length in order to fuse the optical fibers. In FIG. 2, seven optical fiber couplers are formed, but the number thereof is not limited to it. For example, the multiple optical fiber holder can be manufactured as follows. That is, the distance between the optical fibers composing a pair is 1 mm, the distance between a pair of the optical fibers (optical fiber coupler) and the other pair of the optical fibers (optical fiber coupler) is 2 mm, and the twisted number is 3/2.

On the other hand, the multiple micro torch 130 uses propane gas and oxygen gas as a heat source, and the gas amount injected by a MFC (mass flow controller: not shown) is precisely controlled. Generally, in order to produce the optical fiber coupler having high quality, it is important that a stable temperature is maintained without shaking the flame of the torch. In addition, since the multiple micro torch 130 must uniformly heat the optical fiber by the extent of 2-3 cm in the length direction, it is designed to be moved in the left and right direction. The multiple micro torch moves in the left and right direction and uniformly fuses the portions of the optical fibers, during the carrying stage applies the tensile force to the both ends of the optical fibers. As mentioned above, the polymer jackets of the optical fibers are stripped by the same length and the stripped portions are heated by the micro torch, thereby the fused portions are formed. The portions heated by the multiple micro torch 130, that is, the fused portions are in, for example, the extent of about 2 to 3 cm.

Also, since the optical fibers must be uniformly heated in the length direction thereof, the multiple micro torch 130 moves in left and right direction and uniformly heats the portions of the optical fibers, during the carrying stage pulls the both ends of the optical fibers. The tensile force for the optical fiber is accomplished by the driving motor 160. Hereinafter, the multiple micro torch will be explained.

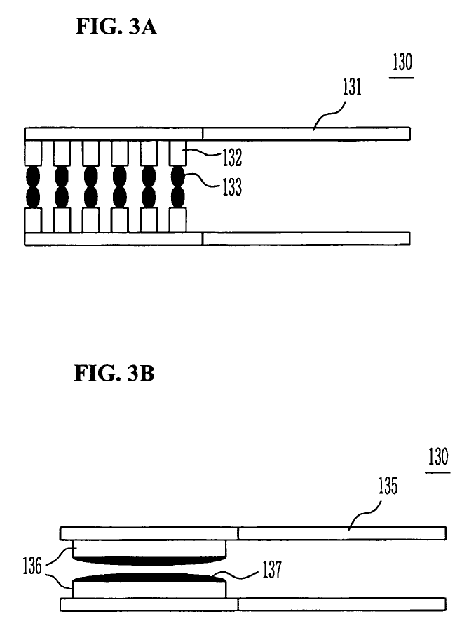

Next, the example of manufacturing the multiple micro torch 130 will be explained with reference to FIGS. 3a and 3b.

Explaining the first example of the multiple micro torch 130 with reference to FIG. 3a, it has a structure that flame 131 independently heats individual optical fiber. The multiple micro torch 130 comprises a torch support 131 and a plurality of the torch tips 132, wherein the torch tips 132 have same structure and the same interval therebetween and are mounted on the torch support 131. The torch tip 132 is symmetrically formed in the upper and lower sides thereof, and the arrangement interval between the torch tips 132 is not specially limited and can be variously changed. For example, the arrangement interval is in extent of about 2 to 10 mm. Each of the plurality of the torch tips 132 shoots flame 133 by adequately adjust the amount of the gas injected from the inside of the torch support 131.

Explaining the second example of the multiple micro torch 130 with reference to FIG. 3b, it has the structure in which the flame 137 is very widely formed. This structure allows several optical fibers to be sufficiently heated at a uniform temperature at once. Also, by adjusting gas injecting amount and the temperature according to each portion, the temperature can be uniformly adjusted. The torch tips 136 have a same structure, and are spaced apart from each other by a uniform interval and mounted on the torch support 135.

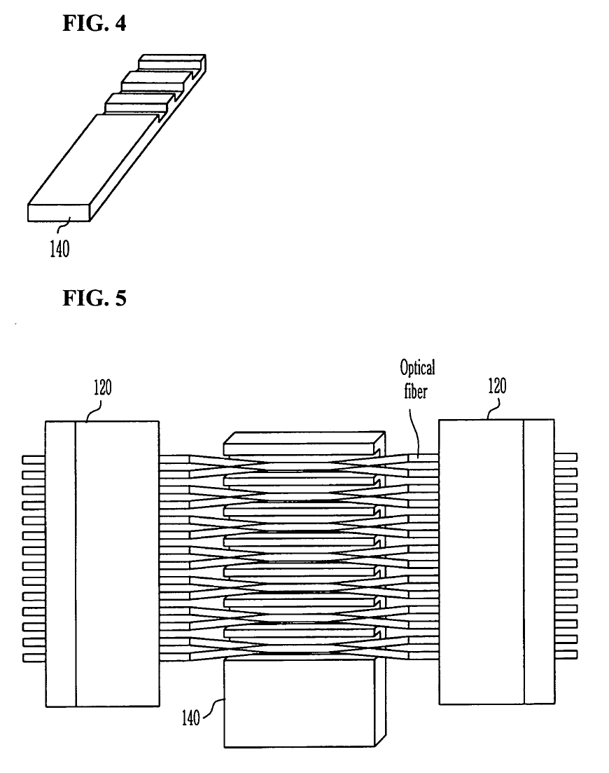

Referring to FIG. 4, the packaging portion 140 is accommodated in the optical fiber coupler manufacturing apparatus, and provides a function of packaging the manufactured optical fiber coupler. Hereinafter, explaining the packaging method, a silica U groove can be used in the packaging method. The end portion of the packaging portion 140 is formed with a U-shaped recess. The U groove is laid on the U-shaped recess and U groove is fixed without being shaken by operating a vacuum pump. The U groove has a U-shaped recess in a silica glass rod having thickness of about 3 mm. The optical fiber coupler having the taper shape is laid on this recess and the end thereof is fixed by an UV epoxy resin, thereby the packaging process is finished. For example, the distance between the recesses can be about 4 to 5 cm. FIG. 5 is a conceptional diagram illustrating the packaging process.

Preferably, since it is advantageous that the packaging process is performed immediately after the optical fiber coupler is manufactured, the packaging portion 140 is designed to be accommodated in the optical fiber coupler manufacturing apparatus. The reason is because the taper portion of the optical fiber coupler has generally length of about 30 mm and therefore the handling thereof is not easy and the coupling characteristic of the coupler can be changed when the coupler is removed from the optical fiber holder 130.

The driving motor 160 performs a function of applying a tensile force to the both ends of the optical fiber while the optical fiber is heated. This function can be performed by pulling the symmetrically arranged multiple optical fiber holders 120 in the direction opposite to each other.

Comparing the present invention with the prior art with respect to the time for manufacturing the optical fiber coupler, it takes about 10 minutes for manufacturing the optical fiber coupler in the prior art, but at least ten optical fiber couplers can be manufactured within ten minutes in the present invention. Accordingly, it is seen that the time for the manufacturing process is remarkably reduced in accordance with the present invention. In addition, the packaging process is carried out at once after the manufacturing process is finished, thereby the cost and the time thereof can be reduced.

In addition, during a plurality of the optical fiber couplers having a same specification such as a same structure and a same optical characteristic are manufactured at once, the optical fiber couplers having a same specification can be produced, even though only the characteristic of one optical fiber coupler is measured and the characteristics of the other optical fiber couplers are not measured.

As mentioned above, according to the present invention, since a plurality of the optical fiber couplers having a same specification can be manufactured at once, inconvenience of measuring the optical fiber couplers one by one can be removed during manufacturing thereof, and there is an excellent effect which can obtain the characteristics of the plurality of the optical fiber couplers by one measurement, thereby the throughput thereof can be improved in case of an actual producing process.

Although the present invention has been illustrated and described with respect to exemplary embodiments thereof, the present invention should not be understood as limited to the specific embodiment, and it should be understood by those skilled in the art that the foregoing and various other changes, omission and additions may be made therein and thereto, without departing from the spirit and scope of the present invention.

What is claimed is:

1. A multiple optical fiber coupler manufacturing apparatus, comprising:
a multiple micro torch for heating portions of a plurality of optical fibers so as to fuse the optical fibers two by two;
multiple optical fiber holders symmetrically arranged in the reference of said multiple micro torch, for fixing the plurality of the optical fibers two by two at a same interval; and
a carrying stage having said multiple micro torch and said multiple optical fiber holders mounted thereon such that said multiple optical fiber holder can be moved.

2. The multiple optical fiber coupler manufacturing apparatus according to claim 1, wherein further comprising a driving motor for fixing and moving the optical fiber in order to move said optical fiber holder.

3. The multiple optical fiber coupler manufacturing apparatus according to claim 1, wherein further comprising a packaging portion for packaging each optical fiber coupler.

4. The multiple optical fiber coupler manufacturing apparatus according to claim 1, wherein the pairs of said plurality of the optical fibers have the same twisted number, and the heating portion of the optical fiber is stripped by the same length, in order to fuse the optical fiber.

5. The multiple optical fiber coupler manufacturing apparatus according to claim 1, wherein said multiple micro torch has a plurality of pairs of torch tips symmetrically arranged at a certain interval, and respective pair of torch tips corresponds to an optical fiber coupler in order to apply flames of respective pair of torch tips to connected portions of individual optical fiber couplers, respectively.

6. The multiple optical fiber coupler manufacturing apparatus according to claim 1, wherein said multiple micro torch has a pair of torch tips symmetrically arranged, and said pair of torch tips corresponds to a plurality of optical fiber couplers in order to apply broad flames of said pair of torch tips to connected portions of the optical fiber couplers.
